(19) United States
(12) Patent Application Publication
(10) Pub. No.: US 2010/0051519 A1
(43) Pub. Date: Mar. 4, 2010

(54) Water treatment device and water treatment method for a passenger aircraft

(76) Inventors: Joachim Maier-Witt, Hamburg (DE); Svenja Lena Riedel, Hamburg (DE); Sebastian Mainusch, Hamburg (DE)

Correspondence Address: MCCRACKEN & FRANK LLP, 311 S. WACKER DRIVE, SUITE 2500, CHICAGO, IL, 60606, US

(21) Appl. No.: 12/583,720

(22) Filed: Aug. 25, 2009

(30) Foreign Application Priority Data
Aug. 26, 2008 (DE) 10 2008 039 667.2

(51) Int. Cl. B01D 35/143

(52) U.S. Cl. 210/89

(57) ABSTRACT

The invention relates to a water treatment device for a passenger aircraft including a water inlet port, a water outlet port, a pipe for connecting the water inlet port to the water outlet port, a filtration device located in the pipe and an electronic control device, wherein the electronic control device is adapted to monitor at least one parameter associated with the status of the filtration device:
volume of water flowing through the filtration device on the basis of a corresponding measuring signal;
time period after a filter exchange in the filtration device; and/or
pressure loss over the filtration device on the basis of a corresponding measuring signal; and, if the monitored parameter fulfils certain criteria, to determine a filter exchange request and to output a filter exchange signal.

The invention relates to a water treatment device and a water treatment method for a passenger aircraft.

In a conventional drinking water circulation system a filtration device comprising a fine-pored fleece serves for mechanically filtering out particles including bacteria. The use of activated carbon filters allows the absorption of chemicals. An irradiation with ultraviolet light is carried out for sterilizing the circulating water. However, the effect of the filtration device may rapidly decrease depending on the operating conditions, in particular on the water flow rate, so that particularly at the end of the exchange cycles an effective filtration is not always guaranteed. The UV irradiation devices are expensive and susceptible; moreover, a disinfectant effect using UV irradiation has not been proven beyond doubt.

DE 10 2007 062 925 discloses a water filtration device comprising a mechanical exhaustion indicator located on the filter housing.

DE 297 07 278 relates to a filtration device in a bottle washing machine.

JP 10 235120 A discloses a filter unit comprising a plurality of parallel-connected filters, wherein the water flowing through the filter unit is measured using a flow rate sensor, and wherein a control device deactivates a first filter and activates a second filter as soon as the measured water volume has reached a predetermined value.

It is the object of the invention to provide a cost-effective and reliable device for water treatment as well as a corresponding method, wherein an effective water treatment is guaranteed at any time independent of the respective operating conditions.

The invention solves this object with the means of the independent claims. According to the invention, the electronic control device is adapted to monitor a parameter associated with the status of the filtration device. If the control device determines that the monitored parameter fulfils certain criteria indicating a filter status with a reduced filtration effect, a filter exchange request is determined and a filter exchange signal is output in order to induce a manual or automatic filter exchange. The invention therefore at any time reliably guarantees a high filtration effect and thus a consistently high water quality independent of the respective operating conditions and in particular independent of the total water flow rate. Hereby, a sufficient sterilization effect may already be achieved using filtration. According to the invention, the conventional UV irradiation may then be omitted.

The monitored parameter is suited to determine a filter status with a reduced filtration effect requiring an exchange of the filter. This may be a parameter on the basis of a measuring signal provided by a corresponding sensor, in particular the total volume of water refilled since the last filter exchange and/or a pressure loss over the filtration device. As an alternative or in addition this may also be a parameter available in the control device, in particular the time period since the last filter exchange.

Preferably a plurality of these parameters, further preferably all of these parameters are monitored individually in order to enhance the reliability in determining a filter with a reduced effect and to increase the cost efficiency. For example, solely applying the criterion “time period after a filter exchange in the filtration device” may lead to an unnecessary exchange of an unused filter in a mainly parked aircraft. On the other hand, solely applying the criterion “volume of water flowing through the filtration device” may lead to a filter which is to be exchanged for hygienic reasons not being exchanged in an aircraft parked for a long time. Therefore, the filter exchange request is preferably determined in a suitable manner depending on both aforementioned criteria.

The electronic control device is preferably adapted to turn off the drinking water system in the event of a filter not being exchanged, in order to avoid an operation with a filtration effect being too low.

The water treatment device preferably includes at least one further filtration device connected parallel to the filtration device. If the electronic control device determines a filter exchange request for the filtration device in operation the same can be deactivated and the other unused filtration device can be activated without the need to interrupt the operation of the drinking water system. By means of this redundancy the service life of the filtration device can for example be doubled.

The filtration device preferably includes at least one pre-filter and at least one fine filter.

The invention is preferably applicable in a drinking water circulation system comprising a ring pipe connecting different tapping points, wherein a continuous water circulation is maintained in said ring pipe. However, the invention may in particular be applied in an ordinary drinking water system without a ring pipe connecting different tapping points.

According to a preferred aspect of the invention either in the drinking water system or on the ground between the water service vehicle and the aircraft filling port a water softening device is provided. This may be an ion exchange device or a device using another method for avoiding precipitation of calcium carbonate, for example an intentional calcification method using a granulate material having the property to induce the calcium dissolved in the water to form calcite crystals precipitating on the surface of the granulate material; these crystals grow and finally break off. The water softening device provides the possibility to carry out water softening in order to protect components, for example air humidifiers, against calcium carbonate damages, and, if necessary, to adjust the desired water hardness. As it has not been known so far to use aircraft-bound water softening devices or water softening devices located on the ground between the water service vehicle and the aircraft filling port, this aspect is independent, i.e. it may be protected by filing a divisional application independent of the aspect of the filter status monitoring.

Preferably, the water softening device is essentially completely drainable. This may be expedient in particular in parked aircrafts in order to avoid frost damages or germ formation.

When the water softening device is preferably connected between a filling port for the drinking water system and the fresh water supply device, it is ensured that all the refilled water can be softened without the water softening device increasing the flow resistance between the supply device and the tapping point.

When the drinking water system preferably comprises a by-pass pipe connected parallel to the water softening device and a valve for switching between the water softening device and the by-pass pipe, a desired water hardness can be adjusted for example by controlling the valve using the electronic control device.

The electronic control device is preferably adapted to monitor a parameter associated with the status of the water softening device. If the control device determines that the monitored parameter fulfils certain criteria indicating a softener status with a reduced softening effect, a softener exchange request is determined and a softener exchange signal is output in order to induce a manual or automatic softener exchange. Therefore, a high softening effect and thus a consistently high water quality is reliably guaranteed at any time independent of the respective operating conditions and in particular independent of the total amount of refilled water.

The monitored parameter is suited to determine a softener status with a reduced softening effect requiring an exchange of the softener. This may be a parameter on the basis of a measuring signal provided by a corresponding sensor, in particular the total volume of water refilled since the last softener exchange. As an alternative or in addition this may also be a parameter available in the control device, in particular the time period since the last softener exchange. Preferably, a plurality or all of these parameters are monitored individually in order to enhance the reliability in determining a reduced softening effect.

The softener exchange may be carried out in different ways, in particular by feeding or discharging substrate to or from the water softening device, by feeding or discharging a regenerating substance to or from the water softening device or by exchanging a cartridge containing substrate.

The filter exchange request as well as the softener exchange request may preferably be displayed visually for an operator.

The term “drinking water system” within the scope of this application also includes water systems which do not provide a strict drinking water quality.

In the following, the invention is described in more detail on the basis of preferred embodiments with reference to the attached figures, wherein these figures show:

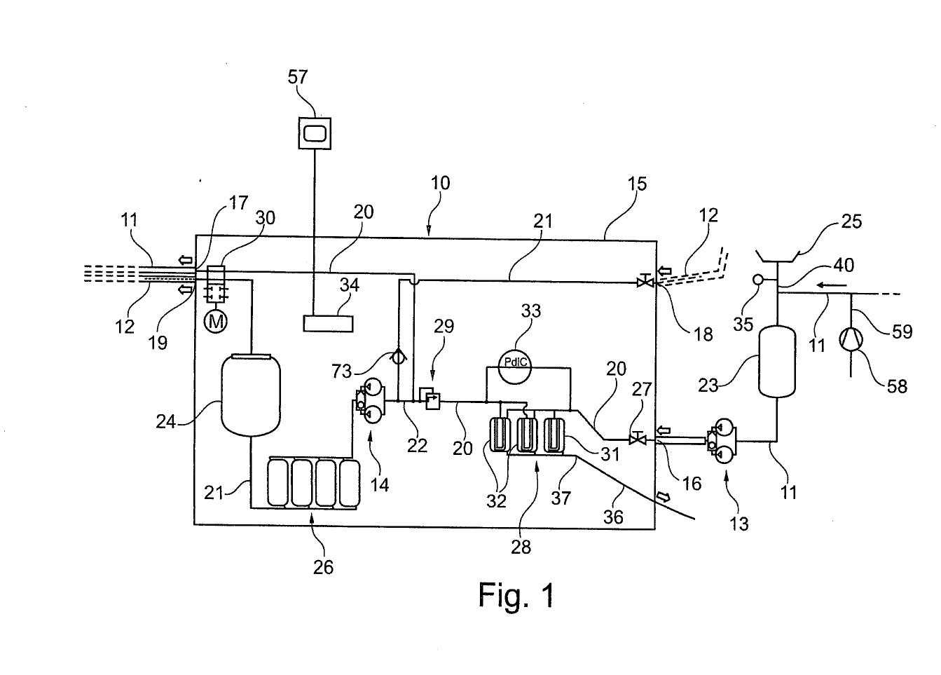

FIG. 1: a schematic representation of a cut-out of a drinking water circulation system;

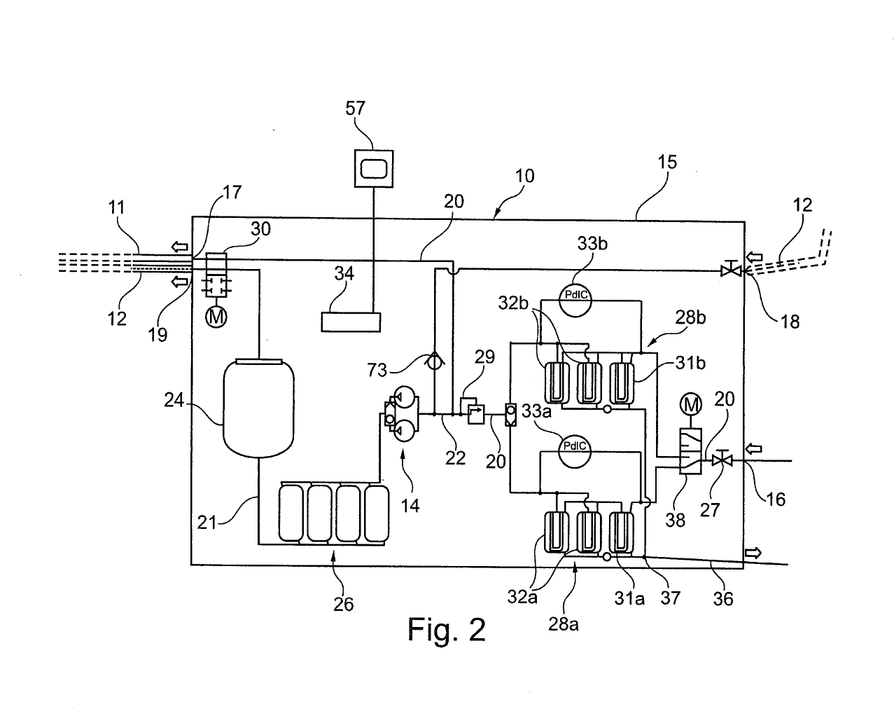

FIG. 2: a schematic representation of a cut-out of another embodiment of a drinking water circulation system;

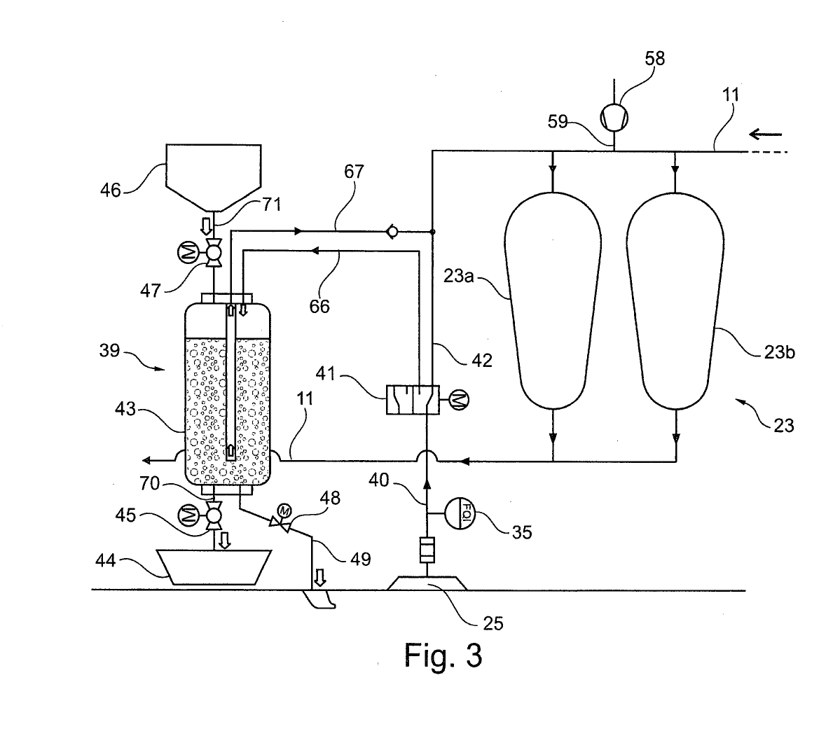

FIG. 3: a schematic representation of a cut-out of a drinking water system;

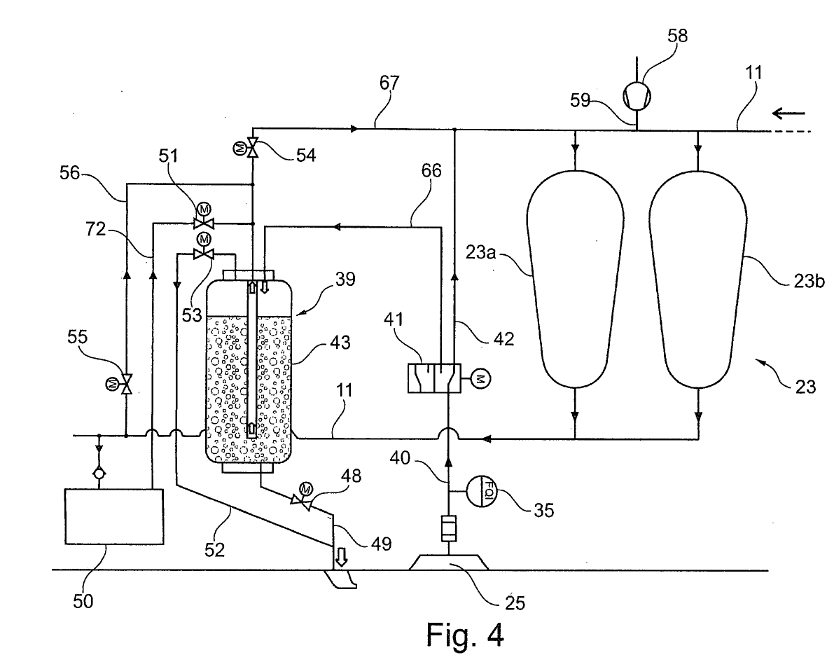

FIG. 4: a schematic representation of a cut-out of another embodiment of a drinking water system;

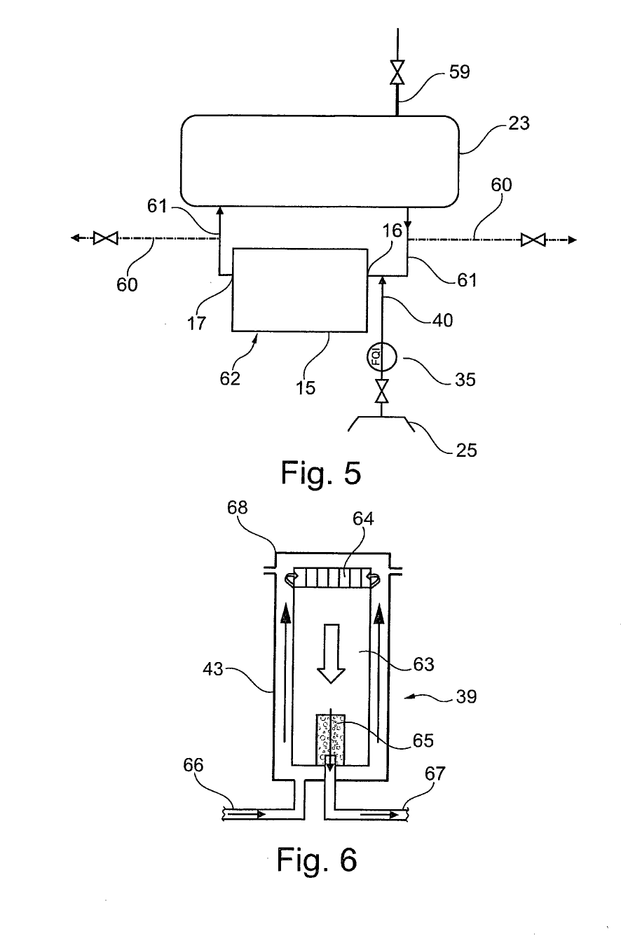

FIG. 5: a schematic representation of a cut-out of a further embodiment of a drinking water system; and

FIG. 6: a schematic representation of an ion exchange device.

The water treatment device 10 forms part of a drinking water circulation system in a passenger aircraft comprising a fresh water ring pipe 11 and a hot water ring pipe 12 which are not completely shown in the figures. The ring pipes 11, 12 are guided closely past the drinking water tapping points in the aircraft, as for example water taps, toilets, bidets, showers, drinking water dispensers, steam baths, air humidifiers in order to be connected to the same. The pumping devices 13, 14 serve for generating a continuous circulation of the water in the ring pipes 11, 12 and for overcoming the flow resistance of the filtration device 28 to be described later on. The circulating motion allows a continuous treatment and a constant tempering of the water, and prevents local icing of the pipes and development of biofilm in the pipes.

The circulation system includes a fresh water tank device 23, from which fresh water is withdrawn, pumped through the ring pipe 11 using the pumping device 13, which here is designed to be redundant, and finally conducted back to the tank device 23. When a fresh water tapping point is opened fresh water is withdrawn from the tank device 23, the water level of which falls accordingly, by applying pressure using a compressor 58 via a compressed-air line 59 and a pump 13. In order to refill the fresh water tank device 23 a filling port 25 is provided, wherein the volume of refilled water may for example be measured using a flow rate sensor 35.

The fresh water ring pipe 11 in the water treatment device 10 is formed by a fresh water pipe 20. For this purpose, a housing 15 of the water treatment device 10 comprises corresponding inlet ports and outlet ports 16, 17. A shut-off valve 27, a filtration device 28 and a pressure regulator 29 are connected into the fresh water pipe 20. The filtration device 28 preferably includes at least one coarse filter 31 and at least one, here two fine filters 32 as well as one drainage connector 37 connected to a drainage pipe 36. All filters of the filtration device 28 may be combined in an exchangeable filter cartridge. A differential pressure sensor 33 is connected parallel to the filtration device 28 for measuring the pressure loss over the filtration device 28.

The hot water ring pipe 12 in the water treatment device 10 is formed by a hot water pipe 21. For this purpose, the housing 15 of the water treatment device 10 comprises corresponding inlet ports and outlet ports 18, 19. A non-return valve 73, a water heater 26, where appropriate a relatively small hot water storage tank 24 and a pumping device 14, which here is designed to be redundant, for pumping hot water through the ring pipe 14 are connected into the hot water pipe 21. An electrically driven controllable valve 30 for shutting off the water pipes 20, 21 is provided in order to interrupt the circulation in the water treatment device 10. Using a pipe 22 which is preferably located in the water treatment device 10 the hot water ring pipe 12 is connected to the fresh water ring pipe 11 so that water from the fresh water ring pipe 11 may replenish the hot water ring pipe 12 if hot water is withdrawn from a tapping point.

Furthermore, an electronic programmable or programmed control device 34 is provided which may be located in the water treatment device 10 or which may be designed as a separate structural unit. The electronic control device 34 may in particular be realized in an already provided electronic control unit of the aircraft, for example for the drinking water system. The electronic control device 34 in particular serves for monitoring the status of the filtration device 28. For this purpose, the electronic control device 34 is expediently programmed to monitor one or more status parameters of the filtration device 28, as will be described in the following.

The electronic control device 34 thus is preferably connected to the flow rate sensor 35 for monitoring the volume of refilled water and comprises an electronic memory for storing a value representing the total volume of water refilled since the last filter exchange. If the total volume of water refilled since the last filter exchange exceeds a certain value it may be assumed that the filter capacity of the filtration device 28 is exhausted. The control device 34 then determines a filter exchange request for the filtration device 28 and outputs a corresponding filter exchange signal.

Furthermore, the control device 34 is preferably connected to the differential pressure sensor 33 for independently monitoring the pressure loss over the filtration device 28. With increasing time of operation the filter resistance increases and the flow rate decreases accordingly. If the measured flow rate falls below a certain value it may be assumed that the filter capacity of the filtration device 28 is exhausted. The electronic control device 34 then independently determines a filter exchange request for the filtration device 28 and outputs a corresponding filter exchange signal. Thus, an exhaustion of the filter capacity may be determined in due time even with water having a higher filtration demand.

Finally, the electronic control device 34 preferably comprises an electronic memory for storing a value representing the total time passed since the last filter exchange. If the filters in the filtration device 28 have reached a certain age it may be assumed that the filter capacity is no longer sufficient owing to ageing-caused wear. The electronic control device 34 then determines an independent filter exchange request for the filtration device 28 and outputs a corresponding filter exchange signal.

Depending on the filter exchange signal output by the electronic control device 34 different actions may be taken. The filter exchange request may in particular be displayed on a monitor 57 in the aircraft in order to request a qualified person to exchange a filter cartridge of the filtration device 28. In the event of a required filter exchange not being carried out in due time, which may for example be determined by the pressure loss over the filtration device exceeding an admissible upper limit, the control device 34 may arrange for the circulation system to be automatically turned off for example using the valve 30.

When the filter exchange has been carried out, the aforementioned electronic memories for storing a value representing the total volume of water refilled since the last filter exchange, and a value representing the total time passed since the last filter exchange are expediently reset.

In the embodiment shown in FIG. 1 the pressure loss is measured over the filtration device 28 as a whole, i.e. over all filters 31, 32. In addition or instead it is possible to independently measure and monitor the pressure loss over single filters 31, 32.

The embodiment according to FIG. 2 differs from the embodiment according to FIG. 1 in that here two independent filtration devices 28a, 28b which are of identical construction are parallel-connected. Either the filtration device 28a or the filtration device 28b may be connected into the fresh water ring pipe 20 using an electronic valve 38. The valve 38 is actuated by the electronic control device 34. In the event of a filter exchange request being determined for one of the two filtration devices 28a, 28b, the electronic control device 34 actuates the valve 38 in order to effect an automatic switch to the respective other unused filtration device 28b, 28a. Owing to this automated filter exchange the operation of the circulation system needs not to be interrupted for the exchange of the filter cartridge, whereby the time of operation of the circulation system may be doubled.

Of course, also more than two independent filtration devices 28 may be provided.

The embodiment according to FIG. 5 makes clear that the invention cannot only be applied to drinking water circulation systems comprising ring pipes 11, 12 connecting all tapping points, but also to ordinary drinking water systems in which all tapping points are only connected to the tank device 23 via one or more, in the present example two supply pipes 60.

In conventional passenger aircrafts, such stationary systems, i.e. systems working without water circulation, are used for feeding fresh water tapping points in toilets and galleys. The simple connecting pipe 60 to the water tapping points results in a substantially shorter total pipe length compared to circulation systems according to FIG. 1 or 2.

In the embodiment according to FIG. 5, a water treatment device 62 is provided which is connected to the tank device 23 via a local ring pipe 61. “Local” means that the ring pipe 61 is allocated to the tank device 23 and is preferably located near the tank device 23, however, does not serve for connecting the different water tapping points within the aircraft. Thus, the length of the ring pipe 61 is short compared to the biggest distance between two water tapping points within the aircraft.

The water treatment device 62 may in particular have a similar construction as the water treatment device 10 from FIG. 1 or 2, however, without a hot water pipe 21, and comprises a filter status monitoring according to the invention. The pumping device 13 is preferably located in the water treatment device 62. A circulation of the fresh water stored in the tank device 23 can be achieved with little effort using the local ring pipe 61, whereby bacterial contamination of stagnant water in the tank device 23 is prevented.

FIG. 3 shows a cut-out of a drinking water system comprising an ion exchange device 39 located on the input side for softening or decalcifying refilled water. Using an inlet pipe 66 and an outlet pipe 67 into the filling pipe 40 the ion exchange device 39 is interconnected between the filling port 25 and the input side of the tank device 23 which here for example consists of two tanks 23a, 23b. Upstream of the ion exchange device 39 an electrically operated valve 41 is located with which optionally the ion exchange device 39 or a by-pass pipe 42 may be connected into the filling pipe 40. The ion exchange device 39 includes a pressure vessel 43 through which the refilled water flows if the valve 41 is switched accordingly, and which includes a drainage pipe 49 which can be closed using an electric valve 48. The pressure vessel 43 contains a substrate that extracts in particular calcium ions and magnesium ions from the water flowing through and/or releases in particular sodium ions to the water and thus softens the same.

By switching the valve 41 during refilling a mixing ratio of ion-exchanged and non-ion-exchanged water and thus the hardness of the drinking water may be adjusted in the tank device 23. The switching of the valve 41 may in particular be controlled by the electronic control device 34. The electronic control device 34 may carry out the switching on the basis of values for the actual hardness of the water to be refilled and the target hardness of the refilled water entered by an operator via a terminal. Alternatively standard values for the actual hardness of the water to be refilled and the target hardness of the refilled water can be used if no input values are available. The adjustment may be carried out on the basis of the volume flow signal provided by the flow ratio sensor 35.

FIG. 6 shows a further preferred embodiment of an ion exchange device 39. It includes a pressure vessel 43 and an ion exchange cartridge 63 located therein which contains the substrate and comprises a water inlet 64 and a water outlet 65. The pressure vessel 43 includes a detachable cover 68 for exchanging the cartridge 63 if a substrate exchange request is displayed.

The electronic control device 34 is expediently programmed to monitor one or more status values of the ion exchange device 39. This may be carried out in particular on the basis of a measuring signal provided by the flow ratio sensor 35. The electronic control device 34 then expediently comprises an electronic memory for storing a value representing the total volume of water refilled since the last refresh of the ion exchange device 39. If the total volume of water refilled since the last refresh exceeds a certain value depending on the volume of the substrate in the ion exchange device 39 it may be assumed that the ion exchanging capacity of the substrate in the ion exchange device 39 is exhausted. The electronic control device 34 then determines a substrate exchange request for the ion exchange device 39 and outputs a corresponding signal.

An exchange of the substrate of the ion exchange device 39 may be carried out in particular by exchanging the pressure vessel 43 or by exchanging the substrate cartridge 63, by exchanging the substrate itself or by regenerating the substrate, as will be described in the following. In the first-mentioned cases, the substrate exchange request is displayed as a pressure vessel exchange request or a cartridge exchange request in particular on a monitor 57 in the aircraft in order to request a qualified person to exchange the pressure vessel 43 or the cartridge 63 against an unused pressure vessel or an unused cartridge.

In the embodiment according to FIG. 3, the exchange is carried out by an automatic exchange of the substrate itself, that is by discharging the used substrate from the pressure vessel 43 via a discharge pipe 70 into a collecting tray 44 by opening an electric valve 45 and refilling of unused substrate into the pressure vessel 43 from a reservoir 46 via a supply pipe 71 by opening an electric valve 47. The electric valves 45, 47 are expediently controlled automatically by the electronic control device 34 if a substrate exchange request has been determined.

In the embodiment according to FIG. 4 the exchange is carried out by regenerating the substrate, that is by automatically feeding a regenerating salt solution from a reservoir 50 to the pressure vessel 43 via a supply pipe 72 by opening an electric valve 51 and draining the flushing fluid through a drainage pipe 52 which is opened using an electric valve 53, while the ion exchange device 39 is separated from the drinking water pipe 67, 11 using an electric valve 54. Subsequently, the valve 51 is closed and the substrate is flushed by supplying water via a pipe 56 which is opened using an electric valve 55, wherein the flushing water again is drained through the drainage pipe 52. The electric valves 51, 53, 54 and 55 are expediently controlled automatically by the electronic control device 34 if a substrate exchange request has been determined.

The ion exchange devices 39 according to the invention are characterized by being drainable, i.e. that water may be drained from the pressure vessel 43 preferably completely through the pipe 49 after the valve 48 has been opened.

Preferred embodiments of the invention concern drinking water systems comprising a water treatment device 10 according to FIG. 1, 2 or 5 in combination with an ion exchange device 39 according to FIG. 3, 4 or 6.

In a further embodiment not shown the ion exchange device 39 is not aircraft-bound, but is connected in particular between the water service vehicle and the aircraft filling port on the ground. The ion exchange device 39 then may stay on the ground after the refilling process in order to save aircraft dead weight thereby. The ion exchange device 39 in this embodiment is preferably provided in a mobile unit movable on the ground which may as well comprise a filtration device which where appropriate is designed according to the invention for pre-filtering the fresh water and/or a device for adding water treating means preventing the formation of biofilms.

1. A water treatment device for a passenger aircraft including a water inlet port, a water outlet port, a pipe for connecting the water inlet port to the water outlet port, a filtration device located in the pipe and an electronic control device, wherein the electronic control device is adapted to monitor at least one parameter associated with the status of the filtration device:
volume of water flowing through the filtration device on the basis of a corresponding measuring signal;
time period after a filter exchange in the filtration device; and/or
pressure loss over the filtration device on the basis of a corresponding measuring signal;
and, if the monitored parameter fulfils certain criteria, to determine a filter exchange request and to output a filter exchange signal.

2. The device according to claim 1, including at least one sensor for measuring a pressure loss over the filtration device.

3. The device according to claim 1, wherein the electronic control device is adapted to turn off the drinking water system in the event of a filter exchange not being carried out.

4. The device according to claim 1, including at least one further filtration device connected parallel to the filtration device.

5. The device according to claim 1, wherein the electronic control device is adapted to switch from one filtration device, for which a filter exchange request has been determined, to another filtration device.

6. A drinking water system in a passenger aircraft, including a fresh water tank device, at least one ring pipe connected to the tank device for feeding tapping points, and a water treatment device comprising a water inlet port, a water outlet port, a pipe for connecting the water inlet port to the water outlet port, a filtration device located in the pipe and an electronic control device, wherein the electronic control device is adapted to monitor at least one parameter associated with the status of the filtration device:
volume of water flowing through the filtration device on the basis of a corresponding measuring signal;
time period after a filter exchange in the filtration device; and/or
pressure loss over the filtration device on the basis of a corresponding measuring signal;
and, if the monitored parameter fulfils certain criteria, to determine a filter exchange request and to output a filter exchange signal.

7. The drinking water system according to claim 6, including at least one sensor for continuously measuring the volume of the refilled fresh water.

8. The drinking water system according to claim 6, including a water softening device.

9. The drinking water system according to claim 6, wherein the water softening device is drainable.

10. The drinking water system according to claim 6, wherein the electronic control device is adapted to monitor a parameter associated with the status of the water softening device and, if the monitored parameter fulfils certain criteria, to determine a softener exchange request and to output a softener exchange signal.

11. The drinking water system according to claim 6, wherein the electronic control device is adapted to determine the softener exchange request if a total volume flow determined on the basis of a corresponding measuring signal is exceeded.

12. The drinking water system according to claim 6, wherein the electronic control device is adapted to control a device for feeding and discharging substrate and/or a regenerating substance to or from the water softening device if a softener exchange request has been determined.

13. The drinking water system according to claim 6, wherein the water softening device includes an exchangeable cartridge containing substrate.

14. The drinking water system according to claim 6, including a controllable display device for visually displaying a filter exchange request and/or a softener exchange request if a corresponding control signal is received from the control device.

15. A water treatment method for a passenger aircraft using a filtration device, characterized by automatically monitoring at least one parameter associated with the status of the filtration device:
volume of water flowing through the filtration device on the basis of a corresponding measuring signal; time period after a filter exchange in the filtration device; and/or a pressure loss over the filtration device on the basis of a corresponding measuring signal; and, if the monitored parameter fulfils certain criteria, determining a filter exchange request and outputting a filter exchange signal.
